(19) United States
(12) Patent Application Publication
(10) Pub. No.: US 2008/0117903 A1
(43) Pub. Date: May 22, 2008

(54) Apparatus and method for high speed and large amount of data packet capturing and replaying

(75) Inventor: Sezen Uysal, Vienna, VA (US)

Correspondence Address: SEZEN UYSAL, 9318 KILBY GLEN DR., VIENNA, VA, 22182, US

(73) Assignee: Sezen Uysal, Vienna, VA (US)

(21) Appl. No.: 11/875,359

(22) Filed: Oct. 19, 2007

Related U.S. Application Data
(60) Provisional application No. 60/862,239, filed on Oct. 20, 2006.

(51) Int. Cl. H04L 12/56

(52) U.S. Cl. 370/389

(57) ABSTRACT

This invention is an apparatus and a method to capture large amount of live packet traffic at high speeds into volatile memory first and then saving them into non-volatile memory for future replays. Direct capturing packets into system memory allows achieving theoretical maximum speed of the network media, for example 1.4 million packets with 64 byte size per second for gigabit Ethernet networks. Captured packets, which are eventually saved in the non-volatile memory, can be replayed later, optionally by modifying the speed and the content of the traffic in real time. Similarly while replaying packets, the system moves the packets into volatile memory first and then sends them from there to achieve high speeds. Optionally filtering can be used to selectively capture and replay certain packets.

### BACKGROUND OF INVENTION

Packet capturing is used for various reasons such as monitoring, security, network or application analysis. Similarly packet replaying is used to mimic a live traffic for regenerating certain network traffic or conditions in an controlled test environment.

The main challenge of the packet capturing is to achieve high speeds and to receive every packet that are seen in the network. Generating packets from previously captured packets at high speed is also not an easy task on today's server systems using general purpose processors.

There are various solutions to provide high speed traffic capturing and replaying. All of these solutions use either a network processor, an ASIC designed to have high speed packet capture or an FPGA solution programmed for high speed packet processing. All of these solutions are expensive and not flexible for future speeds and additional functionalities as underlying packet processing hardware is specifically designed for these tasks only.

This invention proposes a software solution running on a general purpose PC to capture and replay packets at high speed.

### SUMMARY OF INVENTION

A method for high speed packet capturing and replaying on a PC system is introduced. A software application running at operating system's (for example Linux, FreeBSD, or Unix) memory space captures and replays packets to/from a dedicated section of the volatile system memory.

Carefully written software application receives the packets from network interface card and directly puts them into reserved memory space without using any memory copying functions which creates latency and hence low packet capturing speeds.

Similarly, directly accessing packets without any copy functions from a reserved memory location and sending them to network interface card allows users to achieve high speed packet replaying.

As memory prices are relatively low and there are PC systems which provides systems with large memory space it is possible to capture and replay a lot of network traffic at high speed.

An additional application running on an idle processor is used to write and read from non-volatile memory system (e.g. RAID system, fast flash memory) for processing much larger traffic amounts.

### BRIEF DESCRIPTION OF DRAWINGS

FIG. 1 depicts functional block diagram of the invention. It also shows the flow of packets during both capturing and replaying.

FIG. 2 depicts system components of the invention. It also shows how the components are connected in reference to flow of packets.

### DETAILED DESCRIPTION

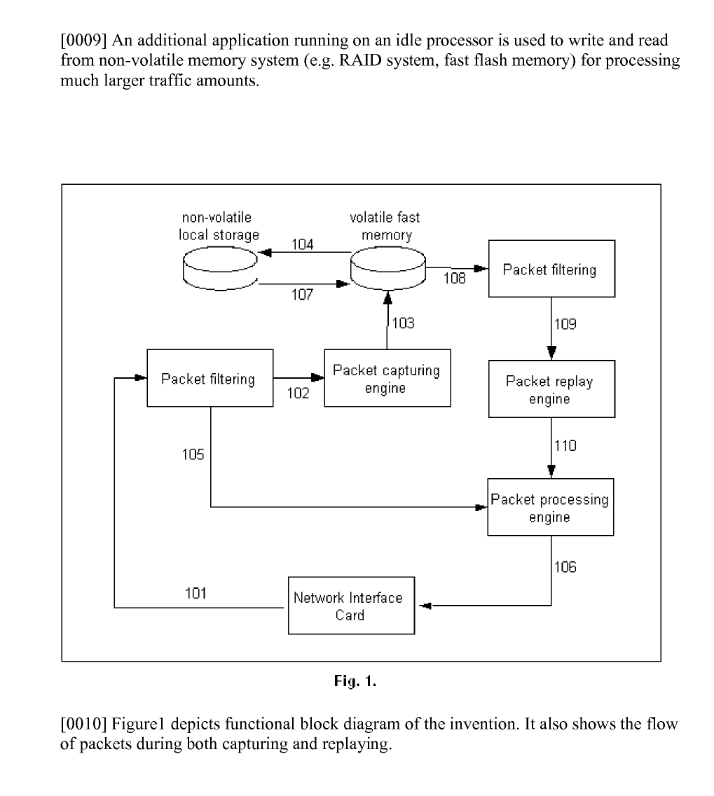

FIG. 1 shows the functional block diagram and the flow of captured and replayed packets. The system consists of at least one high speed Network Interface Card (NIC), a computer system with a volatile memory and a local or an external non-volatile data storage system.

When NIC receives packets (101), the packets are first examined by the packet filtering module. Packet filtering allows capturing only significant packets and either delete or forward the non-matching packets (105, 106). Then the packets are processed by the packet capturing engine to mark their arrival times (102) and to be moved to volatile memory (103). Fast volatile memory provides a buffer to move packets in chunks at high speeds directly into memory system without performing any high latency memory copying operations.

During that process, optionally another application empties the buffer by storing the packets into a non-volatile memory system such as RAID, or into fast flash memory in real-time or after capturing is over (104). These packets can be processed for analysis or for high speed replay.

During replay, packets are read from the storage media (107) into the fast volatile memory. Optionally, packets can be filtered to pick certain ones to replay (108). After filtering, packets are processed by the replay engine for scheduling their sent times (109). The packets can be replayed either at their original speed or they can be sent at different speeds. Again optionally, packet contents can be modified or some network impairments such as packet loss, jitter can be introduced by the processing engine (110). Finally packets are processed by the NIC for transmission (106).

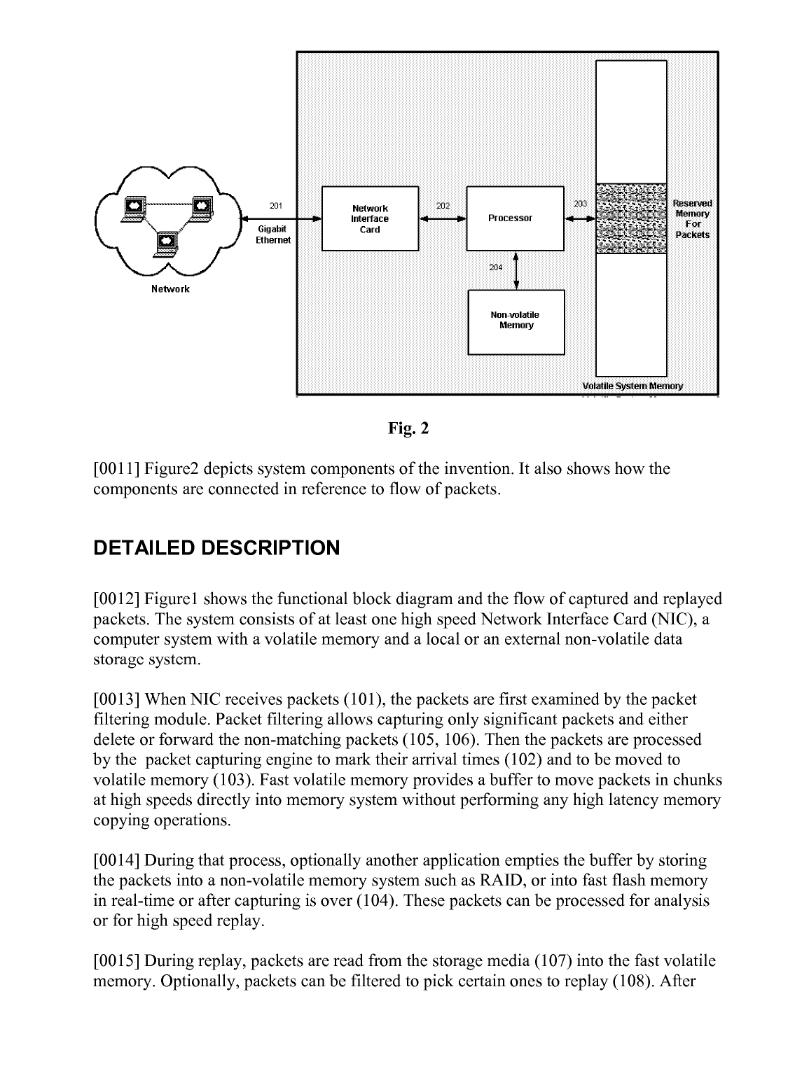

FIG. 2 shows the system components and depicts the operations at the hardware and software component level. The Ethernet packets are first received by the Network Interface Card (NIC), (201). After marking the arrival times inside the packet data structure, the NIC with the help of processor moves the packets (202) to the dedicated memory location in the volatile system memory (203). A software application would then process these packets for filtering and moving them to the non-volatile memory for future processing or replaying (204).

Packet replaying works in a similar way but in opposite order. Packets previously stored in the non-volatile memory are first moved to the reserved memory location (204, 203). After optionally filtering, the NIC is informed to send the packets based on the original arrival times of the packets (202, 201).

During the capturing and replaying processes packets are copied only once in volatile memory to and from the non-volatile memory to minimize the processing latency. With this method, theoretical wire speed of the network media can be achieved.

1. An apparatus for capturing packets from a network connection into a volatile memory directly without any memory copy operations to achieve high capturing speeds; said apparatus containing non-volatile memory, volatile memory, generic Ethernet network interface cards, and general purpose processors with Intel architecture.

2. An apparatus for replaying packets from a volatile memory system directly to a generic network connection without any memory copy operations to achieve high replaying speeds; said apparatus containing non-volatile memory, volatile memory, generic Ethernet network interface cards, and general purpose processors with Intel architecture.

3. A method for capturing packets into a volatile memory system directly without any memory copy operations to achieve high capturing speeds; said method using non-volatile memory, volatile memory, generic Ethernet network interface cards, and general purpose processors with Intel architecture.

4. A method for replaying packets from a volatile memory system directly without any memory copy operations to achieve high replaying speeds; said method using non-volatile memory, volatile memory, generic Ethernet network interface cards, and general purpose processors with Intel architecture.

5. An apparatus for saving captured packets into a non-volatile memory during packet capturing or after capturing by directly copying into non-volatile storage system without any memory copy operations and by using an available idle processor.

6. A method for saving captured packets into a non-volatile memory during packet capturing or after capturing by directly copying into non-volatile storage system without any memory copy operations and by using an available idle processor.
